(19) United States
(12) Patent Application Publication
(10) Pub. No.: US 2013/0128170 A1
(43) Pub. Date: May 23, 2013

(54) LIQUID CRYSTAL DISPLAY DEVICE

(71) Applicants: Myong Ho Kwon, Cheonan-si (KR); Chang-Jin Lee, Busan (KR); Chang-Gil Lee, Hwaseong-si (KR); Tae-Sik Kim, Seoul (KR); Hwal Choi, Busan (KR)

(72) Inventors: Myong Ho Kwon, Cheonan-si (KR); Chang-Jin Lee, Busan (KR); Chang-Gil Lee, Hwaseong-si (KR); Tae-Sik Kim, Seoul (KR); Hwal Choi, Busan (KR)

(73) Assignee: Samsung Mobile Display Co., Ltd., Yongin-city (KR)

(21) Appl. No.: 13/415,137

(22) Filed: Mar. 8, 2012

(30) Foreign Application Priority Data
Nov. 18, 2011 (KR) 10-2011-0121043

(51) Int. Cl. G02F 1/136

(52) U.S. Cl. 349/43

(57) ABSTRACT

A liquid crystal display device is disclosed which, according to one aspect, includes first and second substrates facing each other and a liquid crystal layer interposed between the first and second substrates. The first substrate includes a plurality of first pixels arranged in a first pixel column and a plurality of second pixels arranged in a second pixel column. The first pixels and the second pixels are connected to different ones of a plurality of gate lines and connected to any one of a plurality of data lines.

### CROSS-REFERENCE TO RELATED APPLICATIONS

This U.S. non-provisional patent application claims priority under 35 U.S.C. §119 of Korean Patent Application No. 10-2011-0121043, filed on Nov. 18, 2011, the entire contents of which are hereby incorporated by reference.

### BACKGROUND

1. Field

The technical field relates to a liquid crystal display device, and more particularly, to a liquid crystal display device having improved display quality.

2. Description of the Related Technology

Generally, a liquid crystal display device includes a first substrate including a number of pixel electrodes, a number of switching devices connected to the number pixel electrodes respectively, a number of gate lines, and a number of data lines connected to the number of switching devices respectively. Further, the liquid crystal display device includes a second substrate including a common electrode facing the first substrate.

Generally, a liquid crystal display device will alternately drive a data voltage and a common electrode voltage to improve display quality and prevent a reduction in performance of the liquid crystal when applying a DC voltage. A driving method including an alternating common voltage is such that an alternate common voltage alternating between a high level voltage and a low level voltage is applied to the common electrode.

In a landscape type of liquid crystal display device, it may be advantageous to reduce the width of a black matrix of an upper and lower portion to reduce the thickness of the displays. To reduce the width of a black matrix, pixel electrodes disposed in different pixel lines may be configured to share a data line.

Since a liquid crystal display device in which the number of the data lines is reduced has twice as many gate lines as that of a conventional liquid crystal display device, if a conventional inversion driving method of data signal and an alternating common voltage driving method is applied and as a resolution requirements of the display are increased, a fill factor of liquid crystal declines. As a result, a display quality of liquid crystal display device may be reduced. Further, a delay of the common voltage occurs along pixel lines on which pixels are disposed, and thereby a vertical line artifact may be displayed.

### SUMMARY OF CERTAIN INVENTIVE ASPECTS

According to one embodiment, a liquid crystal display device is disclosed. The liquid crustal display device includes a first substrate comprising a plurality of first pixels arranged in a first pixel column and a plurality of second pixels arranged in a second pixel column, a gate drive unit connected to a plurality of gate lines, the gate drive unit being configured to apply a gate signal to the gate lines during a plurality of frame periods, the gate lines being provided on the first substrate, a data drive unit connected to a plurality of data lines, the data drive unit being configured to apply a data signal to the data lines, the data lines being insulated from the gate lines and being arranged in planes intersecting planes of the gate lines, a second substrate facing the first substrate and comprising a common electrode, a common drive unit configured to apply a common alternating voltage to the common electrode, and a liquid crystal layer interposed between the first substrate and the second substrate. The first pixels and the second pixels are connected to different ones of the gate lines and connected to any one of the data lines. The frame periods comprise a first frame period and a second frame period immediately following the first frame period, and the gate drive unit is configured to apply the gate signal such that the order that the gate signal is provided to the gate lines in the first frame period is different from the order that the gate signal is provided to the gate lines in the second frame period.

According to another embodiment, a liquid crystal display device is disclosed. The liquid crystal display device includes a first substrate comprising a plurality of first pixels arranged in a first pixel column and a plurality of second pixels arranged in a second pixel column, a gate drive unit connected to a plurality of gate lines, the gate drive unit being configured to apply a gate signal during one of a plurality of frame periods, the gate lines being provided on the first substrate, a data drive unit connected to a plurality of data lines, the data drive unit being configured to apply a data signal to the data lines, the data lines being insulated from the gate lines and being arranged in planes intersecting the planes of the gate lines, a second substrate facing the first substrate and comprising a common electrode, a common drive unit being configured to apply an alternating common voltage to the common electrode, and a liquid crystal layer interposed between the first substrate and the second substrate. The first pixels and the second pixels are connected to different ones of the gate lines and connected to any one of the data lines, and each of the second pixels has an area smaller than that of the first pixels.

### BRIEF DESCRIPTION OF THE DRAWINGS

FIG. 1 is a block diagram of liquid crystal display device according to some embodiments.

FIG. 2 illustrates a display panel illustrated in FIG. 1.

FIG. 3 is an enlarged top plan view of section AA illustrated in FIG. 2.

FIG. 4 is a cross sectional view taken along the line I-I′ illustrated in FIG. 3.

FIG. 5 is an enlarged view of a display panel illustrated in FIG. 2.

FIG. 6 is a timing diagram of signals according to some embodiments.

FIG. 7 is a block diagram of gate drive part illustrated in FIG. 1.

FIG. 8 illustrates a display panel of liquid crystal display device according to some other embodiments.

FIG. 9 is an enlarged top plan view of section BB illustrated in FIG. 8.

### DETAILED DESCRIPTION OF CERTAIN INVENTIVE EMBODIMENTS

Some embodiments will be described more fully hereinafter with reference to the accompanying drawings, in which some are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

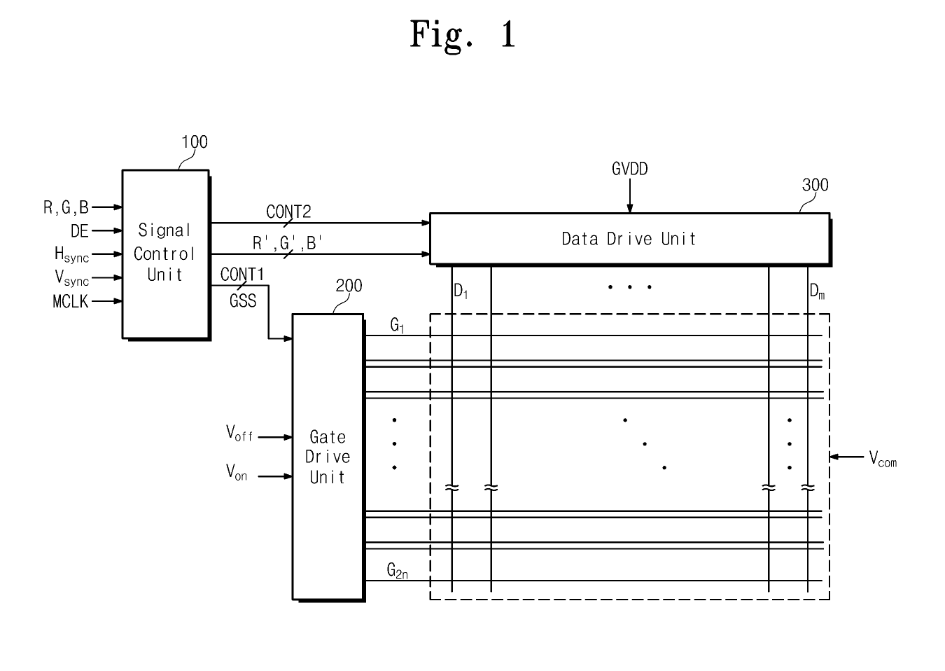

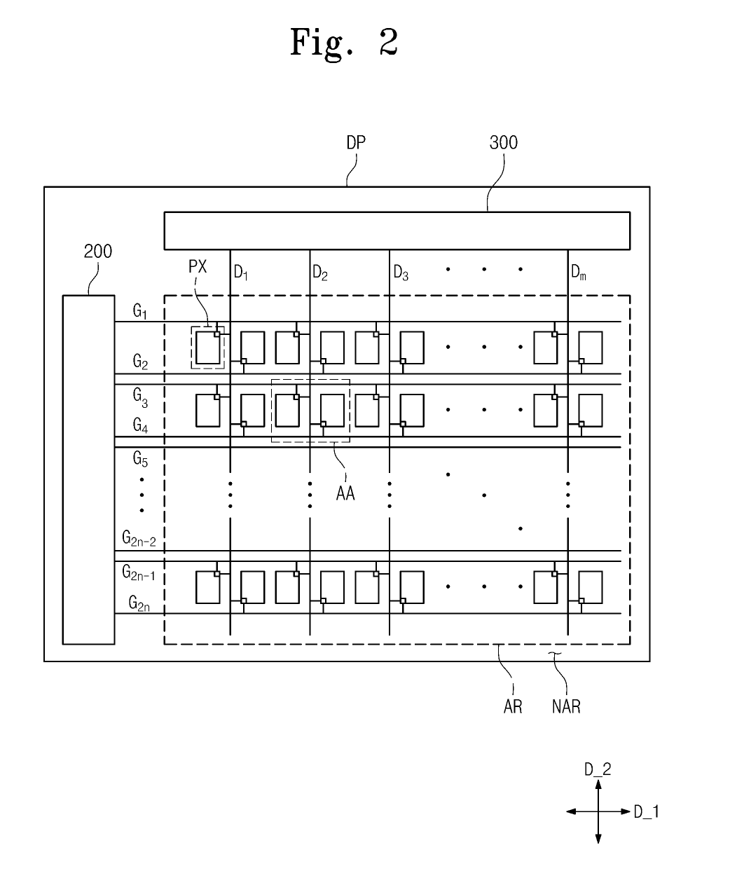

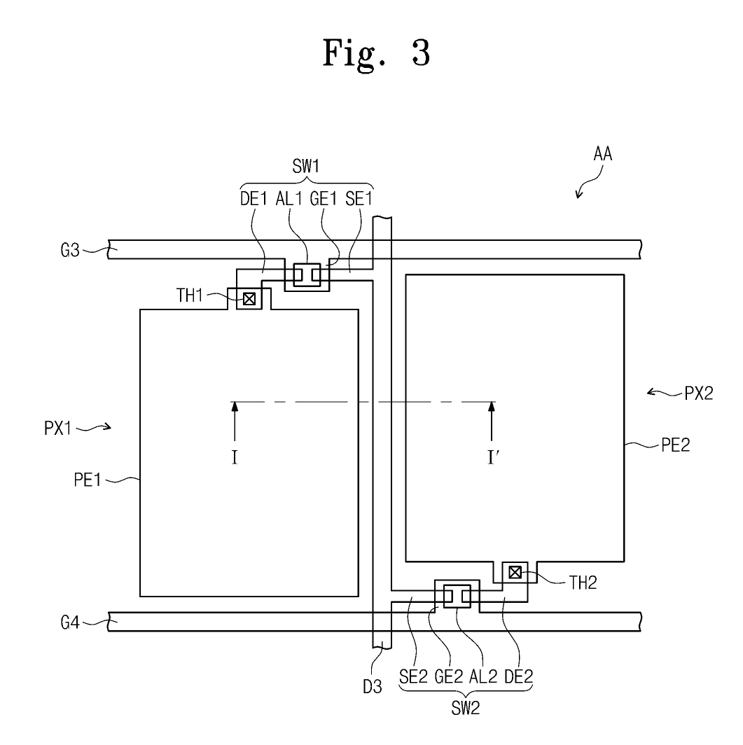

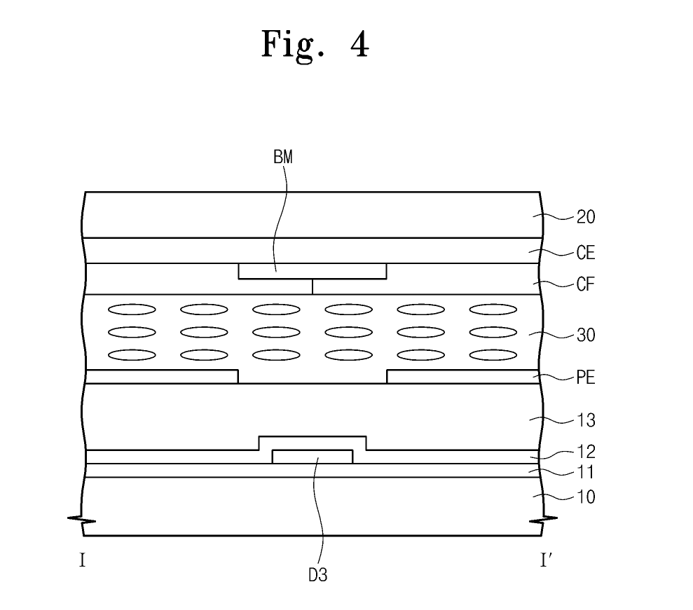

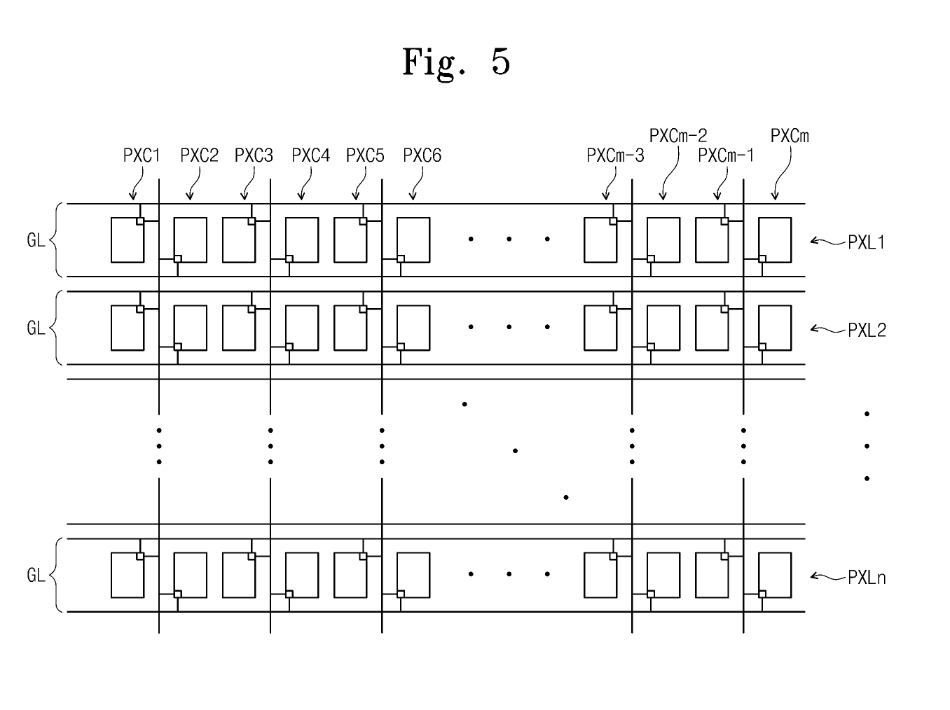

FIG. 1 is a block diagram of liquid crystal display device according to some embodiments. FIG. 2 illustrates a display panel illustrated in FIG. 1. FIG. 3 is an enlarged top plan view of section AA illustrated in FIG. 2. FIG. 4 is a cross sectional view taken along the line I-I′ illustrated in FIG. 3. FIG. 5 is an enlarged view of a display panel illustrated in FIG. 2. A second substrate 20 which will be described in greater detail below is omitted in FIGS. 2 and 3.

With reference to FIGS. 1 through 4, a liquid crystal display device according to some embodiments includes a display panel DP, a signal control part 100, a gate drive unit 200 and a data drive unit 300.

As illustrated in FIG. 4, the display panel DP includes a first substrate 10 and a second substrate 20 spaced apart from the first substrate 10 and facing the first substrate 10. A liquid crystal layer 30 is interposed between the first substrate 10 and the second substrate 20.

As illustrated in FIG. 2, a plurality of first interconnection lines extending in a first direction D_1 and a plurality of second interconnection lines extending in a second direction D_2 crossing the first direction D_1 and being insulated from the first interconnection lines are shown. The first interconnection lines are described to be gate lines G₁-G₂ₙ and the second interconnection lines are described to be data lines D₁-Dₘ.

The first substrate 10, as illustrated in FIG. 2, includes a display area AR configured to display an image and an area NAR configured not to display an image adjacent to a part of the display area AR. A plurality of pixels (PX) are provided on the display area AR.

In FIG. 3, two pixels PX1 and PX2 included in different pixel lines are illustrated. As illustrated in FIG. 3, each of the pixels PX1 and PX2 includes switching devices SW1 and SW2 and pixel electrodes PE1 and PE2.

The common electrode CE, as illustrated in FIG. 4, is spaced apart from the pixel electrodes PE1 and PE2. The arrangement of the liquid crystal layer 30 is changed by an electric field formed by the common electrode CE and the pixel electrodes PE1 and PE2.

The pixels PX1 and PX2 are described in detail with reference to FIGS. 3 and 4. Herein, the description is done in regard to pixel PX1.

The switching device SW1 may be a thin film transistor. The switching device SW1 is connected to one of the gate lines G₁-G₂ₙ and one of the data lines D₁-Dₘ. The switching device SW1 outputs a data signal in response to a gate signal.

The switching device SW1 includes a gate electrode GE1 which branches off from one of the gate lines G₁-G₂ₙ. The gate electrode GE1 may have a shape configured to protrude from one of the gate lines G₁-G₂ₙ on the flat.

The gate lines G₁-G₂ₙ and a gate insulating film 11 covering the gate electrode GE1 is provided on the first substrate 10.

The switching device SW1 includes an activation layer AL1 formed on the gate electrode GE1 with the gate insulating film 11 between them. On the flat portion, the activation layer AL1 overlaps the gate electrode GE1. The activation layer AL1 may include a metal oxide having a semiconductor property. That is, the activation layer may be an oxide semiconductor and may include at least one of a zinc oxide, a zinc tin oxide, a zinc indium oxide, a zinc gallium oxide, and a zinc indium gallium oxide.

The plurality of data lines D₁-Dₘ are provided on the gate insulating layer 11. The switching device SW1 includes a source electrode SE1 that branches off from one of the data lines D₁-Dₘ. At least a part of the source electrode SE1 overlaps the gate electrode GE1 and the activation layer AL1 on the flat.

The switching device SW1 includes a drain electrode DE1 disposed to be spaced apart from the source electrode SE1 on a flat portion.

A protective film 12 and a planarization film 13 covering the drain electrode DE1, the source electrode SE1 and the data lines D₁-Dₘ are provided on the first substrate 10. One of the protective film 12 and a planarization film 13 may be excluded.

The pixel electrode PE1 is provided on the planarization film 13. The pixel electrode PE1, as illustrated in FIG. 3, is connected to the drain electrode DE1 through a contact hole TH1. The pixel electrode PE1 receives the data signal through the drain electrode DE1. A thin film transistor having a bottom gate structure is described herein as an example, however, the switching device SW1 may be configured as a thin film transistor having a top gate structure.

A color filter CF is provided on the second substrate 20. The color filter 20 may also be provided on the common electrode CE. Colors of color filters included in the pixels PX1 and PX2 may be different from each other.

A black matrix BM is provided on the second substrate 20. The black matrix BM corresponds to the data lines D₁-Dₘ provided on the first substrate 10.

In the embodiment discussed above, the color filter CF and the black matrix BM are described as being provided on the second substrate 20. However, the color filter CF and the black matrix BM may be provided on the first substrate 10.

A connection relation among the pixels PX, the gate lines G₁-G₂ₙ and the data lines D₁-Dₘ will be described in detail with reference to FIGS. 2 and 5.

The pixels PX may be arranged in an n×m matrix shape. As referred to herein, n and m are integers which have a value of two or more. The pixels PX are included in any one pixel column among a plurality of pixel columns PXC1-PXCm and are included in any one pixel line among a plurality of pixel lines PXL1-PXLn.

The plurality of pixel columns PXC1-PXCm includes a first pixel column PXC1 and a second pixel column. PXC2. The plurality of pixel columns PXC1-PXCm is repeated by a unit of the first pixel column PXC1 and the second pixel column PXC2. That is, odd number pixel columns PX3, PX5, . . . , PXCm−1 are the same with the first pixel column PXC1 and even number pixel columns PX4, PX6, . . . , PXCm are the same with the second pixel column PXC2.

The first pixel column PXC1 and the second pixel column PXC2 may each include a plurality of pixels PX. A plurality of pixels arranged in the first pixel column PXC1 is defined as a first pixel and a plurality of pixels arranged in the second pixel column PXC2 is defined as a second pixel.

As illustrated in FIGS. 2 and 5, the plurality of first pixels and the plurality of second pixels are connected to respective ones of the plurality of gate lines G₁-G₂ₙ.

For instance, a pixel PX arranged in the first pixel column PXC1 and the first pixel line PXL1 is connected to a first gate line GL₁ and a pixel PX arranged in the second pixel column PXC2 and the second pixel line PXL2 is connected to a first gate line GL₂.

The plurality of gate lines G₁-G₂ₙ may be defined as a plurality of gate line groups GL. Each of the gate line groups GL has a first gate line and a second part gate line which are successively arranged. The odd number gate lines G₁, G₃, . . . , G₂ₙ₋₁ may be the first gate line and the even number gate lines G₂, G₄, . . . , G₂ₙ may be the second gate lines.

Among the plurality of first pixels and the plurality of second pixels, two pixels arranged in the same pixel line are connected to the first part gate line and the second part gate line respectively. For instance, a pixel PX arranged in the first pixel column PXC1 and the second pixel line PXL2 is connected to the third gate line G₃ and a pixel PX arranged in the second column PXC2 and the second pixel line PXL2 is connected to the fourth gate line G₄. Also, a pixel PX arranged in the first pixel column PXC1 and the nth pixel line PXLn is connected to the n−1th gate line Gₙ₋₁ and a pixel PX arranged in the second column PXC2 and the nth pixel line PXLn is connected to the nth gate line Gₙ.

The plurality of first pixels and the plurality of second pixels are connected to respective ones of the plurality of data lines D₁-Dₘ. For instance, the first pixels included in the first pixel column PXC1 and the second pixels included in the second pixel column PXC2 are connected to the first data line D₁.

As described herein, a pixel being connected to the gate line may refer to a connection through a switching device included in the pixel to the gate line. Further, a pixel being connected to the data line may refer to a connection between a switching device included in the pixel to the data line.

With returned reference to FIG. 1, the signal control unit 100, the gate drive unit 200 and the data drive unit 300 are described in detail.

The signal control unit 100 receives an image signal R, G, B from an external graphic control unit (not shown) and a control signal controlling the image signal R, G, B. The control signal includes a vertical synchronization signal Vsync, a horizontal synchronization signal Hsync, a main clock signal MCLK and a data enable signal DE. The signal control unit 100 processes the image signal R, G, B and the control signal to generate an operation condition of display panel DP, generates a gate control signal CONT1 and a data control signal CONT2 and outputs the gate control signal CONT1 and the data control signal CONT2.

The gate control signal CONT1 is provided to the gate drive unit 200. The gate control signal CONT1 may include a vertical synchronization signal Vsync directing the beginning of output of gate on-pulse (a high period of gate signal), a gate clock signal controlling the time of output of the gate on-pulse and an output enable signal limiting a width of the gate on-pulse.

The data control signal CONT2 is provided to the data drive unit 300. The data control signal CONT2 may include a horizontal synchronization signal Hsync directing the beginning of input of image data R′, G′, B′, a load signal directing the provision of corresponding data signal to the data lines D₁-Dₘ, a reverse signal reversing the polarity of data signal with respect to the common voltage and a data clock signal.

The gate drive unit 200 is connected to the gate lines G₁-G₂ₙ. The gate drive unit 200 receives the gate control signal CONT1 and provides a gate signal formed by a combination of a gate on-voltage Von and a gate off-voltage Voff received from the outside to the gate lines G₁-G₂ₙ during a frame period.

The gate drive unit 200 receives a frame signal GSS output from the signal control unit 100. The gate drive unit 200 distinguishes the present frame period and the next frame period among a plurality of consecutive frame periods on the basis of the frame signal GSS.

The data drive unit 300 is connected to the data line D₁-Dₘ. The data drive unit 300 modulates a reference voltage GVDD received from the outside to be fitted to the image data R′, G′, B′, and then provides the modulated reference voltage GVDD to the data line D₁-Dₘ as a data signal. The data signal provided to each of the data line D₁-Dₘ is provided to the pixel electrode through the switching device.

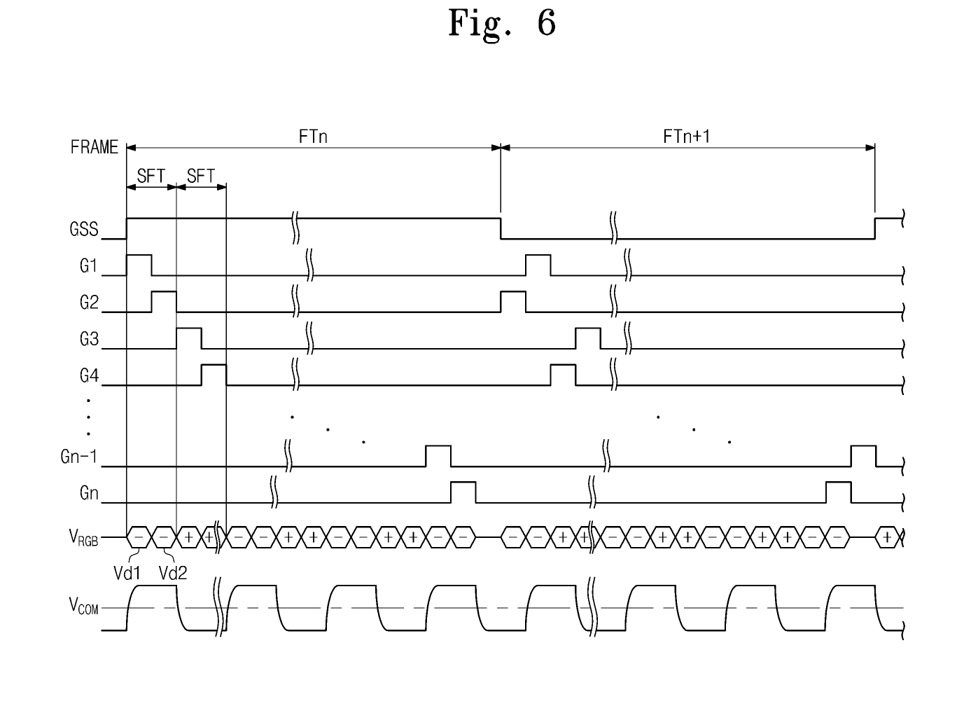

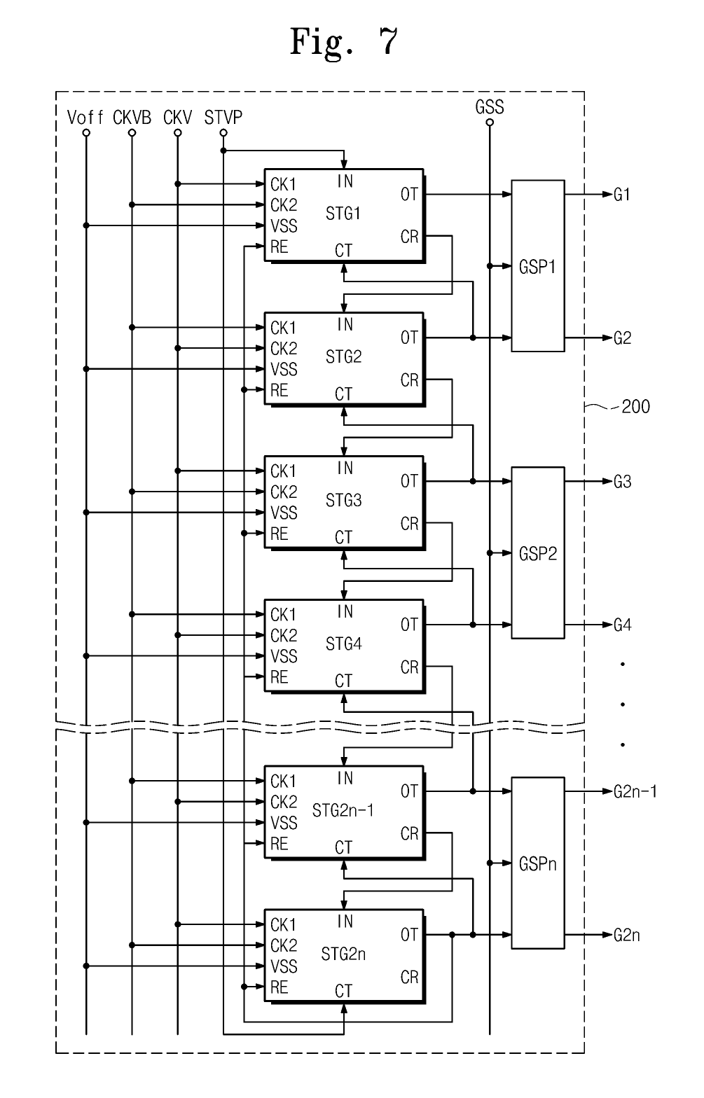

A method of driving a liquid crystal display device according to some embodiments is described with reference to FIGS. 6 and 7. FIG. 6 is a timing diagram of signals according to some embodiments. FIG. 7 is a block diagram of gate drive unit illustrated in FIG. 1.

As illustrated in FIG. 6, the common voltage Vcom provided to the common electrode CE via a common drive unit (not shown) is an alternate voltage and swings between a high level and a low level. The high level may be a positive polarity and the low level may be a negative polarity.

A period in which the gate signal is provided to the gate line group GL is defined as a sub period SFT. Each of the frame periods FT includes the plurality of sub-periods SFT.

The common voltage Vcom swings in consecutive two sub-periods SFT among the sub-periods SFT. The common voltage Vcom may have a high level in the first sub-period SFT of the two sub-periods SFT and may have a low level in the second sub-period SFT of the two sub-periods SFT.

The frame signal GSS has different levels in the consecutive frame periods. In the nth frame period (FTn: hereinafter, it is referred to as a first frame period), the frame signal GSS may have a high level and in the n+1th frame period (FTn+1: hereinafter, it is referred to as second frame period), the frame signal GSS may have a low level.

The order that the gate signal is provided to the gate line group GL in the second frame period FTn+1 is different from that in the first frame period FTn.

During the first frame period FTn, the gate drive unit 200 provides the gate signal to the first gate line, and then provides the gate signal to the second gate line. According to one example, the first gate line corresponds to a top gate line connected to a display element as shown in FIG. 5 while the second gate line may refer to a bottom gate line connected to the same display element in the display array as shown in FIG. 5. Following the first frame period FTn, during the second frame period FTn+1, the gate drive unit 200 provides the gate signal to the second gate line, and then provides the gate signal to the first gate line.

For instance, during the first frame period FTn, the gate signal is provided to the first gate line G1, and then the gate signal is provided to the second gate line G2. Following the first frame period FTn, during the second frame period FTn+1, the gate signal is provided to the second gate line G1, and then the gate signal is provided to the first gate line G1.

As illustrated in FIGS. 5 and 6, during a first sub-period SFT of the consecutive two sub-periods SFT, the data drive unit 300 provides a data signal of first level to each of the data lines D₁-Dₘ and during a second sub-period SFT of two consecutive sub-periods SFT, the data drive unit 300 provides a data signal of second level to each of the data lines D₁-Dₘ. The data signal of first level may be a voltage of level lower than the common voltage of the first sub-period and the data signal of second level may be a voltage of level higher than the common voltage of the second sub-period. For instance, when the common voltage is at a high level, the data signal of first level may be a voltage of negative polarity and when the common voltage is at a low level, the data signal of the second level may be a voltage of positive polarity.

The data drive unit 300 outputs a data signal V_{RGB} to the data lines D₁-Dₘ twice during one sub-period SFT.

During the first frame FTn, a data signal Vd1 which is output first is provided to a pixel connected to the first unit gate line and a data signal Vd2 which is output later is provided to a pixel connected to the second unit gate line.

During the first frame FTn, the pixel PX is charged to a difference voltage between the data signal V_{RGB} and the common voltage Vcom. The pixel PX is one capacitor and the pixel electrode PE and the common electrode CE illustrated in FIG. 4 correspond to a pair of electrodes. The liquid crystal layer 30 illustrated in FIG. 4 corresponds to a dielectric substance.

Since the common voltage Vcom alternates, during the first frame period FTn, a charge rate of pixel connected to the first gate line is lower than a charge rate of pixel connected to the second gate line. In the display device according to some embodiments, since during the second frame period FTn+1, the gate signal is provided to the second gate line, and then is provided to the first gate line, a charge rate of pixel connected to the first gate line is higher than a charge rate of pixel connected to the second gate line.

Consequently, during the first and second frame periods FTn and FTn+1, a charge rate of pixel connected to the first gate line is similar to a charge rate of pixel connected to the second gate line. Thus, in the display device, a vertical line artifact may be substantially reduced.

A structure of the gate drive unit 200 according to some embodiments is described in detail with reference to FIG. 7.

The gate drive unit 200 includes a plurality of stages STG1-STG2n and a plurality of signal output units GSP1-GSPn. The plurality of stages STG1-STG2n is connected to be subordinate to each other and is arranged in the second direction D_2. One gate signal output unit is included in every two stages.

Each of the stages STG1-STG2n includes an input terminal IN, first and second clock terminals CK1 and CK2, a control terminal CT, a voltage input terminal Vss, a reset terminal RE, an output terminal OT and a carry terminal CR.

The input terminal IN is electrically connected to a carry terminal CR of the previous stage to receive a previous carry signal. A vertical beginning signal STV beginning a drive of the gate drive unit 200 is provided to an input terminal IN of the first stage STG1 instead of a previous carry signal.

The control terminal CT is electrically connected to an output terminal OT of the next stage to receive a next gate signal. The vertical beginning signal STV is provided to a control terminal CT of the last stage STG2n instead of a next gate signal.

A first clock CKV is provided to first clock terminals CK1 of the odd number stages STG1, STG2, . . . , STG2n−1 and a second clock CKVB having an inverse phase to the first clock CKV is provided to second clock terminals CK2 of the odd number stages STG1, STG2, . . . , STG2n−1. The second clock CKVB is provided to first clock terminals CK1 of the even number stages STG2, STG4, . . . , STG2n and the first clock CKV is provided to second clock terminals CK2 of the even number stages STG2, STG4, . . . , STG2n.

A gate off voltage Voff is provided to the voltage input terminal Vss of the stages STG1-STG2n. The gate off voltage Voff is a ground voltage or a negative voltage.

The carry terminal CR is electrically connected to an input terminal IN of the next stage to provide a carry signal to the next stage.

The stages STG1-STG2n sequentially output gate signals through the output terminals OT.

Each of the gate signal output units GSP1-GSPn receives the gate signal output from two connected stages. For instance, the first gate signal output unit GSP1 receives the gate signal output from the first stage STG1 and the second stage STG2. Hereinafter, the two connected stages are defined as a first stage and a second stage respectively. Also, a gate signal output from the first stage is defined as a first gate signal and a gate signal output from the second stage is defined as a second gate signal.

Each of the gate signal output units GSP1-GSPn receives not only the first gate signal and the second gate signal but also the frame signal GSS. Each of the gate signal output units GSP1-GSPn selectively output the first gate signal and the second gate signal to the first unit gate line and the second unit gate line on the basis of the frame signal.

Each of the gate signal output units GSP1-GSPn may output the first gate signal and the second gate signal to the first gate line and the second gate line respectively when the frame signal is at a high level. Also, each of the gate signal output units GSP1-GSPn may output the first gate signal and the second gate signal to the second gate line and the first gate line respectively when the frame signal is at a low level.

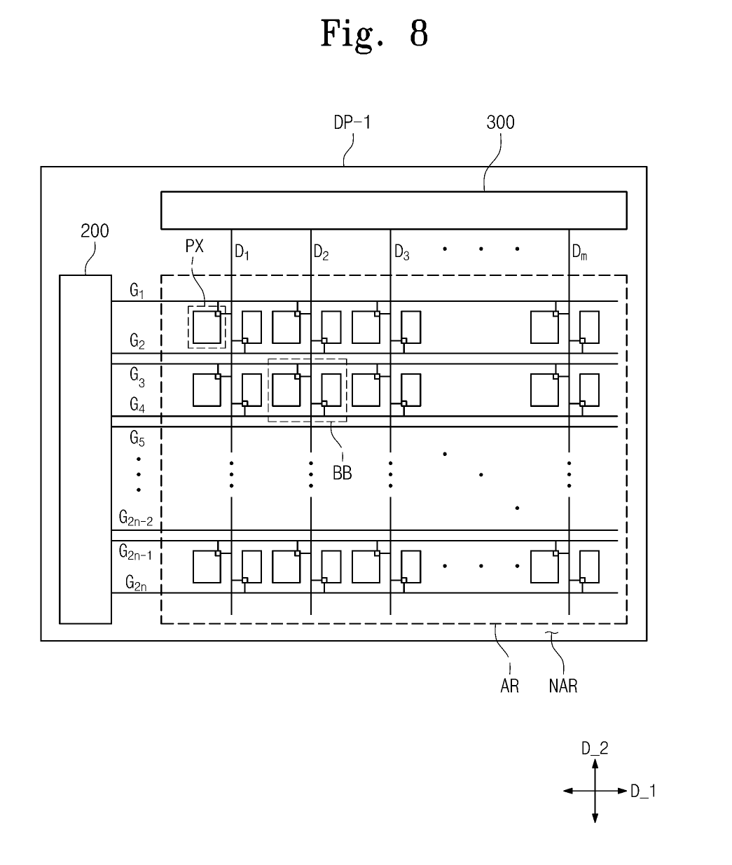

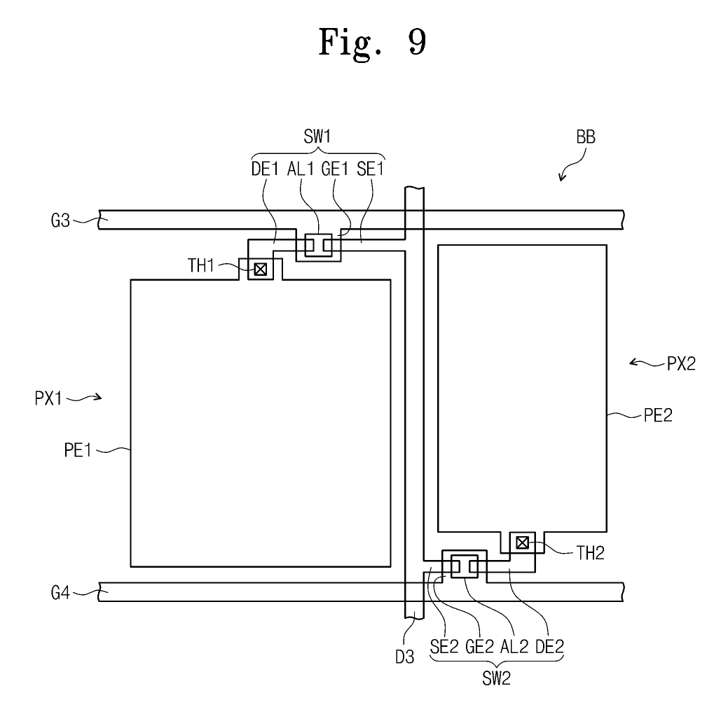

FIG. 8 illustrates a display panel of liquid crystal display device according to some embodiments. FIG. 9 is an enlarged top plan view of BB illustrated in FIG. 8. The display device according to some embodiments is described with reference to FIGS. 8 and 9. Like reference numbers refer to like elements throughout.

The display device according to some embodiments includes the signal control unit 100, the gate drive unit 200, the data drive unit 300 and a display panel DP-1.

The display panel DP-1 includes the first substrate 10, the second substrate 20, the liquid crystal layer 30, the plurality of gate lines G₁-G₂ₙ and the plurality of data lines D₁-Dₘ.

The pixels PX are arranged in an n×m matrix shape. The pixels PX are included in any one pixel column among the plurality of pixel columns PXC1-PXCm and are included in any one pixel line among the plurality of pixel lines PXL1-PXLn.

The plurality of pixel columns PXC1-PXCm includes a first pixel column PXC1 and a second pixel column PXC2. The plurality of pixel columns PXC1-PXCm is repeated by a unit of the first pixel column PXC1 and the second pixel column PXC2. That is, odd number pixel columns PX3, PX5, . . . , PXCm−1 are the same with the first pixel column PXC1 and even number pixel columns PX4, PX6, . . . , PXCm are the same with the second pixel column PXC2.

The first pixel column PXC1 includes a plurality of first pixels PX1 and the second pixel column PXC2 includes a plurality of second pixels PX2.

Two pixels arranged in the same pixel line among the plurality of first pixels PX1 and second pixels PX2 are connected to a first gate line and a second gate line respectively between two connected gate lines.

Each of the plurality of second pixels PX2 has an area smaller than each of the plurality of first pixels PX1. Areas of the plurality of first pixels PX1 are the same with each other and areas of the plurality of second pixels PX2 are the same with each other.

As illustrated in FIG. 9, the first and second pixels PX1 and PX2 include switching devices SW1 and SW2 and pixel electrodes PE1 and PE2 respectively.

The pixel electrode PE2 (hereinafter, it is referred to as a second pixel electrode) included in each of the plurality of second pixels PX2 has an area smaller than the pixel electrode PE1 (hereinafter, it is referred to as a first pixel electrode) included in each of the plurality of first pixels PX1. Areas of the first pixel electrodes PE1 may be the same with each other and areas of the second pixel electrodes PE2 may be the same with each other.

During each of the frame periods FT, the gate drive unit 200 sequentially provides the gate signal to the plurality of gate lines G₁-G₂ₙ. The gate drive unit 200, unlike the things illustrated in FIG. 7, does not include the gate signal output units GSP1-GSPn. Output terminals OT of the stages STG1-STG2n are connected to the gate lines G₁-G₂ₙ respectively.

During each of the frame periods FT, the first and second pixels PX1 and PX2 are charged to a difference voltage between the data signal V_{RGB} and the common voltage Vcom. The amount of charges charged in the first and second pixels PX1 and PX2 is in proportion to areas of the pixel electrodes PE1 and PE2.

Even though the first pixel electrode PE1 has an area greater than an area of the second pixel electrode PE2, since the common voltage swings, the amount of charges charged in the first pixels PX1 is equal to the amount of charges charged in the second pixels PX2. Thus, in the display device according to some embodiments, a vertical line problem is reduced.

In the liquid crystal display device according to some embodiments, the order of the gate signals being provided to the plurality of gate lines is changed by a frame period unit. Thus, a vertical line problem is reduced and a display quality is improved.

Some embodiments disclosed herein include a liquid crystal display device. The liquid crystal display device may include first and second substrates facing each other and a liquid crystal layer interposed between the first and second substrates. The first substrate includes a plurality of first pixels arranged in a first pixel column and a plurality of second pixels arranged in a second pixel column. The first substrate also includes a plurality of gate lines receiving a gate signal respectively during a plurality of frame periods and a plurality of data lines crossing the gate lines and receiving data signals. The data lines may be insulated from the gate lines. The second substrate includes a common electrode receiving a common voltage which alternates. The first pixels and the second pixels are connected to different ones among the gate lines and connected to any one among the data lines. The frame periods include connected first frame period and second frame period. The order that the gate signal is provided to the gate lines in the first frame period is different from the order that the gate signal is provided to the gate lines in the second frame period.

The plurality of gate lines may correspond to a plurality of gate line groups including a first gate line and a second gate line each of which is successively arranged in the array. Two pixels arranged in the same pixel line among the plurality of first pixels and second pixels may be connected to the first gate line and the second gate line respectively.

Each of the plurality of first pixels and second pixels may include a switching device outputting a data signal in response to the gate signal and a pixel electrode receiving the data signal.

A period such that the gate signal is provided to the gate line group may be referred to as a sub-period. A plurality of the sub-periods is provided to each of the plurality of frame periods and the common voltage swings in consecutive two sub-periods among the plurality of sub-periods.

The liquid crystal display device may further includes a gate drive unit providing the gate signal to the plurality of gate lines, and a data drive unit providing the data signal to the plurality of data lines.

In the data drive unit, between consecutive two sub-periods included in the sub-periods, during a first sub-period, the data signal of first level lower than the common voltage in the first sub-period is provided to each of the data lines and during a second sub-period, the data signal of second level higher than the common voltage in the second sub-period is provided to each of the data lines.

The plurality of frame periods includes first frame period and second frame period which is consecutive to the first frame period. In the gate drive unit, during the first frame period, the gate signal is provided to the first gate line, and then is provided to the second gate line and during the second frame period, the gate signal is provided to the second gate line, and then is provided to the first gate line.

The gate drive unit may include a first stage generating a first gate signal, a second stage generating a second gate signal and a gate signal output unit. The gate signal output unit receives the first gate signal, the second gate signal and a frame signal defining the first frame period and the second frame period, and selectively outputs the first gate signal and the second gate signal to the first gate line and the second gate line on the basis of the frame signal.

In the gate signal output unit, when the frame signal is at a high level, the first and second gate signals are provided to the first gate line and the second gate line respectively and when the frame signal is at a low level, the first and second gate signals are provided to the second gate line and the first gate line respectively.

In the liquid crystal display device according to some embodiments, each of the plurality of second pixels may have an area smaller than that of the plurality of first pixels.

Areas of the first pixels are the same with one another and areas of the second pixels are the same with one another.

Each of the first and second pixels includes a switching device and a pixel electrode. A pixel electrode of each of the plurality of second pixels has an area smaller than a pixel electrode of each of the plurality of first pixels.

Two pixels arranged in the same pixel line among the plurality of first and second pixels are connected to the first gate line and the second gate line respectively.

The liquid crystal display device further includes a gate drive unit configured to provide the gate signal to the plurality of gate lines and a data drive unit providing the data signal to the plurality of data lines.

The gate drive unit may be configured to sequentially provide the gate signal to the plurality of gate lines during the frame period.

The above-disclosed subject matter is to be considered illustrative, and not restrictive, and the appended claims are intended to cover all such modifications, enhancements, and other embodiments, which fall within the true spirit and scope of the claims. Thus, the scope of the claims is to be determined by the broadest permissible interpretation of the following claims and their equivalents, and shall not be restricted or limited by the foregoing detailed description.

What is claimed is:

1. A liquid crystal display device comprising:
a first substrate comprising a plurality of first pixels arranged in a first pixel column and a plurality of second pixels arranged in a second pixel column;
a gate drive unit connected to a plurality of gate lines, the gate drive unit being configured to apply a gate signal to the gate lines during a plurality of frame periods, the gate lines being provided on the first substrate;
a data drive unit connected to a plurality of data lines, the data drive unit being configured to apply a data signal to the data lines, the data lines being insulated from the gate lines and being arranged in planes intersecting planes of the gate lines;
a second substrate facing the first substrate and comprising a common electrode receiving a common alternating voltage; and
a liquid crystal layer interposed between the first substrate and the second substrate,
wherein the first pixels and the second pixels are connected to different ones of the gate lines and connected to any one of the data lines,
wherein the frame periods comprise a first frame period and a second frame period which is consecutive to the first frame period, and
wherein the gate drive unit is configured to apply the gate signal such that the order that the gate signal is provided to the gate lines in the first frame period is different from the order that the gate signal is provided to the gate lines in the second frame period.

2. The liquid crystal display device of claim 1, wherein the gate lines comprise a plurality of gate line groups including a first gate line and a second gate line each of which is successively arranged in the array, and
wherein two pixels arranged in the same pixel line among the first pixels and second pixels are connected to the first gate line and the second gate line respectively.

3. The liquid crystal display device of claim 2, wherein each of the first pixels and second pixels comprises:
a switching device configured to output the data signal in response to the gate signal; and
a pixel electrode configured to receive the data signal.

4. The liquid crystal display device of claim 3, wherein a period during which the gate signal is provided to the gate line group comprises a sub-period,
wherein a plurality of the sub-periods is included in each of the frame periods, and
wherein the common voltage alternates in two consecutive one of the sub-periods.

5. The liquid crystal display device of claim 1, wherein the gate lines comprise a plurality of gate line groups including a first gate line and a second gate line that are successively arranged,
wherein a period that the gate signal is provided to each of the gate line groups comprises a sub-period,
wherein a plurality of sub-periods are included in each of the frame periods, and
wherein in the data drive unit, between two consecutive sub-periods included in the sub-periods, during a first sub-period, the data signal having a first level lower than the common voltage in the first sub-period is provided to each of the data lines and during a second sub-period, the data signal having a second level higher than the common voltage is provided in the second sub-period to each of the data lines.

6. The liquid crystal display device of claim 5, wherein the gate drive unit is configured to, during the first frame period, provide the gate signal to the first gate line first and to the second gate line second, and during the second frame period, the gate drive unit is configured to provide the gate signal to the second gate line first and to the first gate line second.

7. The liquid crystal display device of claim 6, wherein the gate drive unit comprises:
a first stage configured to generate a first gate signal;
a second stage configured to generate a second gate signal; and
a gate signal output unit configured to receive the first gate signal, the second gate signal and a frame signal defining the first and second frame periods, the gate signal output unit being further configured to selectively output the first gate signal and the second gate signal to the first gate line and the second gate line based on the frame signal,
wherein a gate signal provided to the first gate line during the first frame period, and during the second frame period, a gate signal provided to the second gate line comprise the first gate signal, and
wherein during the first frame period, a gate signal provided to the second gate line and during the second frame period, a gate signal provided to the first gate line are defined as the second gate signal.

8. The liquid crystal display device of claim 7, wherein the gate signal output unit is configured to, when the frame signal is at a high level, provide the first and second gate signals to the first gate line and the second gate line respectively and when the frame signal is at a low level, provide the first and second gate signals to the second gate line and the first gate line respectively

9. A liquid crystal display device comprising:
a first substrate comprising a plurality of first pixels arranged in a first pixel column and a plurality of second pixels arranged in a second pixel column;
a gate drive unit connected to a plurality of gate lines, the gate drive unit being configured to apply a gate signal during one of a plurality of frame periods, the gate lines being provided on the first substrate;
a data drive unit connected to a plurality of data lines, the data drive unit being configured to apply a data signal to the data lines, the data lines being insulated from the gate lines and being arranged in planes intersecting the planes of the gate lines;
a second substrate facing the first substrate and comprising a common electrode receiving a common alternating voltage; and
a liquid crystal layer interposed between the first substrate and the second substrate,
wherein the first pixels and the second pixels are connected to different ones of the gate lines and connected to any one of the data lines, and
wherein each of the second pixels has an area smaller than that of the first pixels.

10. The liquid crystal display device of claim 9, wherein areas of the first pixels are the equal to one another and areas of the second pixels are the equal to one another.

11. The liquid crystal display device of claim 10, wherein each of the first and second pixels comprises:
a switching device configured to output the data signal in response to the gate signal; and
a pixel electrode configured to receive the data signal, and
wherein a pixel electrode of each of the second pixels has an area smaller than a pixel electrode of each of the first pixels.

12. The liquid crystal display device of claim 9,
wherein the gate lines comprise a plurality of gate line groups, each of the gate line groups including a first gate line and a second gate line that are successively arranged, and
wherein two pixels arranged in the same pixel line among the first and second pixels are connected to the first unit gate line and the second unit gate line respectively.

13. The liquid crystal display device of claim 12, wherein a period that the gate signal is provided to the gate line group comprises a sub-period,
wherein the frame period comprises a plurality of sub-periods and
wherein the common voltage alternates in two consecutive sub-periods among the sub-periods.

14. The liquid crystal display device of claim 13, wherein the gate drive unit is configured to sequentially provide the gate signal to the gate lines during the frame period.

15. The liquid crystal display device of claim 13, wherein in the data drive unit, between two consecutive sub-periods included in the sub-periods, during a first sub-period, the data signal of first level lower than the common voltage in the first sub-period is provided to each of the data lines and during a second sub-period, the data signal of second level higher than the common voltage in the second sub-period is provided to each of the data lines.
